(19) United States
(12) Patent Application Publication
(10) Pub. No.: US 2002/0144124 A1
(43) Pub. Date: Oct. 3, 2002

(54) Method and apparatus to monitor use of a program

(76) Inventors: Eric B. Remer, American Fork, UT (US); David A. King, Highland, UT (US); David L. Remer, Orem, UT (US); Bradley W. Mitchell, Eagle Mountain, UT (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/804,673

(22) Filed: Mar. 12, 2001

(51) Int. Cl. H04L 9/00

(52) U.S. Cl. 713/182; 705/52; 380/231

(57) ABSTRACT

A method and apparatus to monitor the use of a software program is described.

### BACKGROUND

Software programs are easily duplicated using conventional copying technologies. A software program typically comprises a set of instructions that are typically stored in some form of machine-readable media, such as magnetic disk, optical disk, random-access memory (RAM), read-only memory (ROM), and so forth. The task of copying these instructions from one machine-readable media to another is relatively trivial, and may be accomplished any number of ways.

Consequently, various technologies have been developed to control and manage the use of software. One goal of these technologies may be to facilitate the distribution and use of software by authorized users, while minimizing or preventing use of the software by unauthorized users. The term “authorized” may refer to those users permitted to use the software, while “unauthorized” may refer to those users not permitted to use the software. Basis for permission may be, for example, contingent upon paying a fee for use of the program.

One type of technology used to control and manage the distribution and use of software may be generally referred to as a “permission-based” technology. In permission-based technology, the program may have a user enter a passcode prior to allowing the program to execute. The passcode typically comprises a unique combination of alphanumeric characters or symbols. Thus, even if a user were to retrieve an unauthorized copy of the program, it would not operate without the appropriate passcode.

Permission-based technologies, however, are unsatisfactory for a number of reasons. For example, the user may have to undertake the administrative burden of retrieving the passcode prior to using a program. In addition, the user may have to enter the passcode prior to every use of the program. This may be tedious and time-consuming for the user, especially if they make frequent use of the protected software. Moreover, these administrative tasks may become much more burdensome when multiple copies of the program are being executed on multiple machines, such as in a corporate or network environment. Further, if the passcode was compromised unauthorized users may use the passcode to activate illegally copied versions of the software program.

In view of the foregoing, it can be appreciated that a substantial need exists for a method and/or apparatus that solves the above-discussed problems.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 is a system suitable for practicing one embodiment of the invention.

FIG. 2 is a block diagram of a system in accordance with one embodiment of the invention.

FIG. 3 is a block flow diagram of the programming logic performed by a managing program module in accordance with one embodiment of the invention.

FIG. 4 is a block flow diagram of the programming logic performed by a monitored program module in accordance with one embodiment of the invention.

FIG. 5 is a block flow diagram of the programming logic performed by a monitoring program module in accordance with one embodiment of the invention.

### DETAILED DESCRIPTION

In the following detailed description, numerous specific details are set forth in order to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention.

The embodiments of the invention comprise a method and apparatus to securely monitor use of a software program over a network. More particularly, the embodiments of the invention may authorize use of a software program, monitor the use of a software program, and measure the time the software program is in authorized use. The owner may use the measured time for any number of purposes, such as reporting, billing, tracking and so forth.

The embodiments of the invention may reduce the disadvantages associated with conventional permission-based technologies. For example, the user may no longer need to procure and input a passcode prior to using the software program. This may potentially reduce the administrative burden on an authorized user, as well as the risk of a passcode being utilized by unauthorized users. In another example, the costs or fees for use of the software program may vary as usage varies, to more accurately reflect the true commercial value of the software program. This may provide advantages over previous techniques that attempt to gain value from the software program by, for example, selling a single or multi-user license for the software program.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

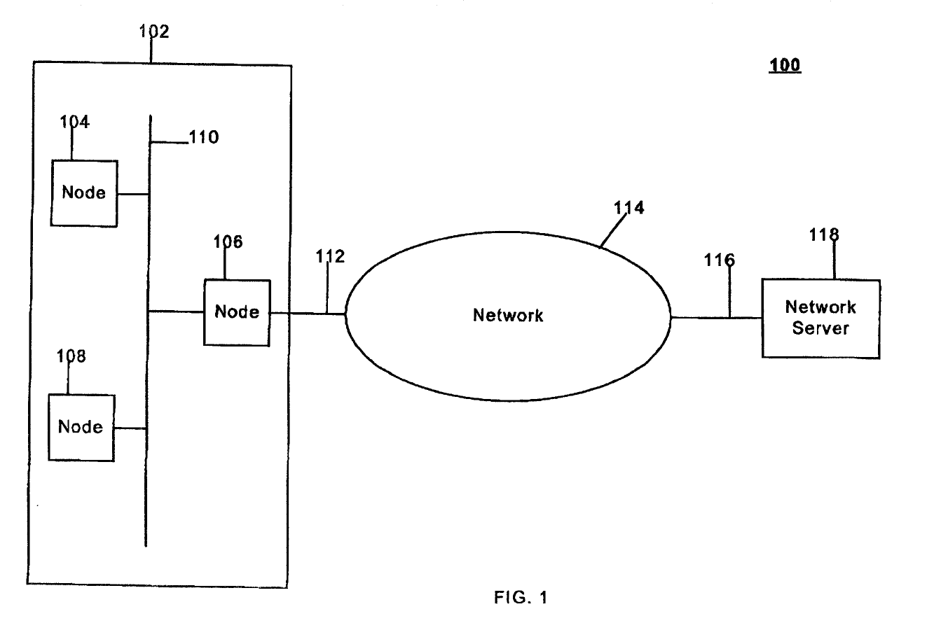

Referring now in detail to the drawings wherein like parts are designated by like reference numerals throughout, there is illustrated in FIG. 1 a system suitable for practicing one embodiment of the invention. FIG. 1 is a block diagram of a system 100 comprising a network 102, a network 114 and a network server 118. In one embodiment of the invention, network 102 may comprise network nodes 104, 106 and 108, with each capable of communicating with each other over a communication medium 110. Network nodes 104, 106 and 108 may comprise, for example, a personal computer, server, network appliance, gateway, router, switch and so forth. Network 102 may be capable of communicating with network 114 over communication medium 112. Network 114 may comprise one or more network nodes (not shown) that are capable of communicating information from network 102 to network server 118. Network 114 may be capable of communicating with network server 118 over communication medium 116. In this embodiment of the invention, network 100 and its various component parts may be configured to operate in accordance with any number of networking technologies, and may include, for example, the various hardware, software and connectors necessary to communicate information between network nodes. In one embodiment of the invention, network 100 is configured to communicate information in accordance with the Transmission Control Protocol (TCP) as defined by the Internet Engineering Task Force (IETF) standard 7, Request For Comment (RFC) 793, adopted in September, 1981, and the Internet Protocol (IP) as defined by the IETF standard 5, RFC 791, adopted in September, 1981, both available from “www.ietf.org” (“TCP/IP Specification”).

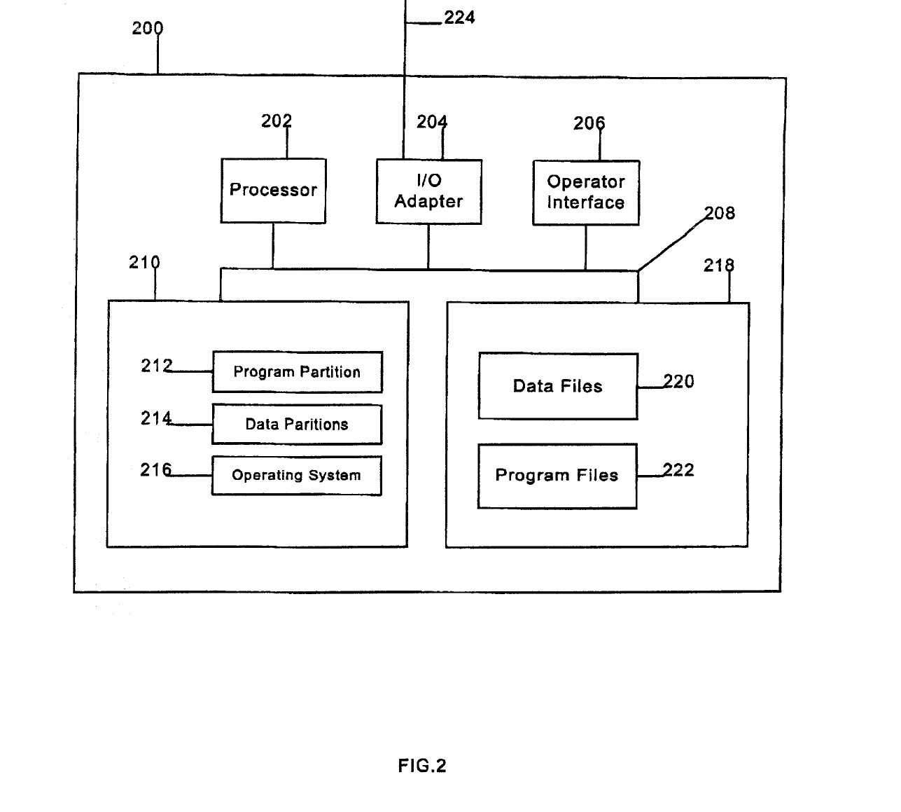

FIG. 2 is a block diagram of a system 200 in accordance with one embodiment of the invention. System 200 may be representative of a network node, such as network nodes 104, 106 and 108, and network server 118, for example. As shown in FIG. 2, system 200 includes a processor 202, an input/output (I/O) adapter 204, an operator interface 206, a memory 210 and a disk storage 218. Memory 210 may store computer program instructions and data. The term “program instructions” may include computer code segments comprising words, values and symbols from a predefined computer language that, when placed in combination according to a predefined manner or syntax, cause a processor to perform a certain function. Examples of a computer language may include C, C++, lisp and assembly. Processor 202 executes the program instructions, and processes the data, stored in memory 210. Disk storage 218 stores data to be transferred to and from memory 210. I/O adapter 204 communicates with other devices and transfers data in and out of the computer system over connection 224. Operator interface 206 may interface with a system operator by accepting commands and providing status information. All these elements are interconnected by bus 208, which allows data to be intercommunicated between the elements. I/O adapter 204 represents one or more I/O adapters or network interfaces that can connect to local or wide area networks such as, for example, the networks described in FIG. 1. Therefore, connection 224 represents a network or a direct connection to other equipment.

Processor 202 can be any type of processor capable of providing the speed and functionality required by the embodiments of the invention. For example, processor 202 could be a processor from family of processors made by Intel Corporation, Motorola Incorporated, Sun Microsystems Incorporated, Compaq Computer Corporation and others. Processor 202 may also comprise a digital signal processor (DSP) and accompanying architecture, such as a DSP from Texas Instruments Incorporated.

In one embodiment of the invention, memory 210 and disk storage 218 may comprise a machine-readable medium and may include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM) and any other media that may store digital information. In one embodiment of the invention, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, system 200 may contain various combinations of machine-readable storage devices through various I/O controllers, which are accessible by processor 202 and which are capable of storing a combination of computer program instructions and data.

Memory 210 is accessible by processor 202 over bus 208 and includes an operating system 216, a program partition 212 and a data partition 214. In one embodiment of the invention, operating system 216 may comprise an operating system sold by Microsoft Corporation, such as Microsoft Windows® 95, 98, 2000 and NT, for example. Program partition 212 stores and allows execution by processor 202 of program instructions that implement the functions of each respective system described herein. Data partition 214 is accessible by processor 202 and stores data used during the execution of program instructions.

Program partition 212 may contain program instructions that may be collectively referred to herein as a monitored program module, a managing program module and a monitoring program module. Of course, the scope of the invention is not limited to this particular set of instructions or groupings of instructions.

In one embodiment of the invention, the monitored program module may reside in the program partition 212 of a system 200 operating as a network node that is part of network 102, such as network node 104, for example. The monitored program module operates to communicate with the managing program module to periodically request authorization to execute a target software program. A target software program as used herein may refer to any software application or program to be monitored for usage. In one embodiment of the invention, the target software program may reside in program partition 212 of network node 104 with the monitored program module, for example.

In one embodiment of the invention, the monitored program module may comprise a combination of instructions added to a target software program and instructions stored as part of a usage library. The term “usage library” as used herein may refer to one or more predefined programming modules available for use by the target software program. In this embodiment of the invention, the predefined programming modules may perform the functions of creating a request for authorization to execute message, sending the request to the managing program, receiving an authorization message with a time interval, receiving a termination message, monitoring a clock to send another authorization message with a time interval, and so forth. Upon activation, the modified target software program may make software calls to one or more predefined programming modules that form the usage library at appropriate times during the execution cycle of the modified target software program. A software call may refer to a request by one program module for execution of instructions stored as part of another program module.

In one embodiment of the invention, the managing program module may reside in program partition 212 of a system 200 operating as the same or another network node that is part of network 102, such as network node 106, for example. The monitored program module operates to communicate with the monitored program module to authorize and track usage of the target software program. The managing program module also communicates with the monitoring program module to communicate usage time for a monitored program. The term “usage time” as used herein refers to the length of time a monitored program is in authorized use or is being executed with authorization.

In one embodiment of the invention, the monitoring program module may reside in program partition 212 of a system 200 operating as a network server, such as network server 118, for example. The monitoring program module operates to communicate with the managing program module to receive time usage information and report the time usage information to an interested party. For example, the monitoring program module may use the time usage information to calculate a cost for using the target software program and bill the appropriate party accordingly.

In one embodiment of the invention, I/O adapter 204 may comprise a network adapter or network interface card (NIC) configured to operate using any suitable technique for controlling communication signals between computer or network devices using a desired set of communications protocols, services and operating procedures, for example. In one embodiment of the invention, I/O adapter 204 may operate, for example, in accordance with the TCP/IP Specification. Although I/O adapter 204 may operate in accordance with the TCP/IP Specification, it can be appreciated that I/O adapter 204 may operate with any suitable technique for controlling communication signals between computer or network devices using a desired set of communications protocols, services and operating procedures, for example, and still fall within the scope of the invention. I/O adapter 204 also includes appropriate connectors for connecting interface 216 with a suitable communications medium. I/O adapter 204 may receive communication signals over any suitable medium such as copper leads, twisted-pair wire, co-axial cable, fiber optics, radio frequencies, and so forth.

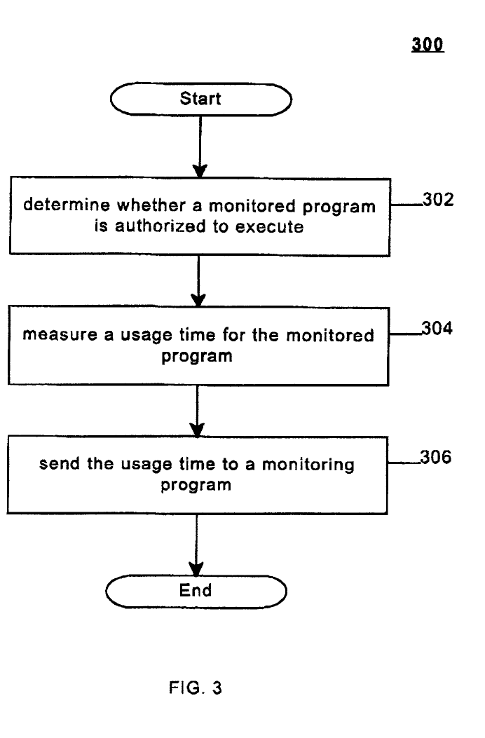

The operations of systems 100 and 200 may be further described with reference to FIGS. 3, 4 and 5 with accompanying examples. Although FIGS. 3, 4 and 5 presented herein may include a particular processing logic, it can be appreciated that the processing logic merely provides an example of how the general functionality described herein can be implemented. Further, each operation within a given processing logic does not necessarily have to be executed in the order presented unless otherwise indicated.

FIG. 3 is a block flow diagram of the programming logic performed by a managing program module in accordance with one embodiment of the invention. The term managing program module refers to the software and/or hardware used to implement the functionality for authorizing and recording the time a target software program is in authorized use or is being executed with authorization as described herein. In this embodiment of the invention, network node 106 may perform the functionality described with reference to the managing program module. It can be appreciated that this functionality, however, may be implemented by any device, or combination of devices, located anywhere in a communication network and still fall within the scope of the invention.

FIG. 3 illustrates a programming logic 300 that when executed by a processor, such as processor 202, may perform the functionality described therein. A determination is made as to whether a monitored program is authorized to execute at block 302. The term “monitored program” as used herein may include a target software program. A usage time for the monitored program is measured at block 304. The usage time is sent to a monitoring program at block 306.

In one embodiment of the invention, the determination at block 302 may be performed using a periodic authorization process. For example, a request for authorization to execute is received from the monitored program. The monitored program is authorized to execute for a time interval. The term “time interval” as used herein may refer to a time period during which the monitored program may be authorized to execute. The time interval is sent to the monitored program. This process may continue on a periodic basis until a terminating event has occurred. Once the terminating event occurs, the time intervals for each repeated process may be added together to form the usage time. For example, if three time intervals were sent to the monitored program prior to the terminating event, the three time intervals would be added together to form the usage time. It can be appreciated that the time intervals may be the same or different and still fall within the scope of the invention.

In one embodiment of the invention, the terminating event may comprise receiving a message indicating use or execution of the program has stopped. For example, the monitored program may receive an instruction to terminate execution by a user. Prior to terminating, the monitored program may send a message to the managing program indicating that the monitored program has received a terminating instruction and therefore will no longer be executing.

In one embodiment of the invention, the terminating event may comprise failing to receive another request for authorization to execute within the time interval. This may occur, for example, if the monitored program has prematurely terminated without time to send a termination message to the managing program, such as in the event of a power failure or computer malfunction.

In one embodiment of the invention, the monitored program and the managing program communicate with each other using a secure method. One example of a secure method may be an encryption/decryption scheme. For example, the monitored program and managing program may communicate to each other using messages encrypted/decrypted in accordance with various security schemes. One embodiment of the invention may use a symmetric scheme, for example. A symmetric scheme as used herein may refer to a security scheme where both parties use the same security code or “key” to encrypt and/or decrypt a secure message. In one embodiment of the invention, the monitored program and managing program are configured to communicate information using a symmetric scheme in accordance with the Data Encryption Standard (DES) or Triple DES (TDES) as defined by the National Institute of Standards and Technology, Federal Information Processing Standards Publication 46-3, Oct. 25, 1995, and available from “http://csrc.nist.gov/cryptval/des/desval.html” (“DES Specification”), although the embodiments of the invention are not limited in this context.

Once a usage time has been determined, the managing program may send the usage time to a monitoring program. The monitoring program may reside at a computer or server other than the monitored program or the managing program, although the invention is not limited in this context. In one embodiment of the invention, the managing program and the monitoring program both reside at a computer or server capable of communicating information in accordance with the TCP/IP Specification. More particularly, the managing program may request a connection formed in accordance with the Hypertext Transfer Protocol (HTTP) as defined by the IETF draft standard RFC 2616, June 1999 (“HTTP Specification), and the Secure HTTP (S-HTTP) as defined by the IETF experimental standard RFC 2660, August 1999 (“S-HTTP Specification), both available from “www.ietf.org,” although the embodiments of the invention are not limited in this context. Once connection is made, the usage time may be sent to the monitoring program over the connection.

Similar to the communications between the monitored program and the managing program, communications between the managing program and the monitoring program may be secure communications. One example of a secure method may be an encryption/decryption scheme. For example, the managing program and monitoring program may communicate to each other using messages encrypted/decrypted in accordance with various security schemes. One embodiment of the invention may use an asymmetric scheme. An asymmetric scheme as used herein may refer to a security scheme where both parties use different keys to encrypt and/or decrypt a secure message. In one embodiment of the invention, the managing program and monitoring program are configured to communicate information using an asymmetric scheme in accordance with the Secure Sockets Layer (SSL) Protocol Version 3.0 Internet draft as defined by the IETF, November 1996 (“SSL Specification”), or the Transport Layer Security (TLS) Protocol draft standard as defined by the IETF RFC 2246, January 1999 (“TLS Specification), both available from “www.ietf.org,” although the embodiments of the invention are not limited in this context. Furthermore, the monitoring program may act as a single trusted source that may issue a certificate of authority for use by the managing program to, for example, authenticate the IP address for the monitored program, managing program or monitoring program.

It is worthy to note that although particular embodiments of the invention may use symmetric or asymmetric security schemes, it can be appreciated that any security scheme may be used to communicate information between the monitored program, the managing program and the monitoring program, and still fall within the scope of the embodiments of the invention.

The managing program may authorize execution for a monitored program in a number of different ways. For example, the managing program may have an authorization table in memory. The authorization table may include, for example, a name for the monitored program, whether the monitored program is authorized to execute, and a predetermined time interval associated with the monitored program. An example of an authorization table is shown in Table 1 below.

TABLE 1

| Monitored Program | Authorization | Time Interval |
|---|---|---|
| Program 1 | Yes | 10 minutes |
| Program 2 | Yes | 1 hour |
| Program 3 | Yes | 1 day |
| Program 4 | No | NA |

Once the managing program receives a request for authorization to execute from the monitored program, the managing program may search the authorization table using the program name. Once the program name is found, the managing program may determine whether the monitored program is authorized to execute, and if so, it may retrieve a predetermined time interval for the monitored program to execute. The managing program may then send the time interval to the monitored program.

For example, if the monitored program is identified as “Program 1,” the managing program may use the authorization table to determine that Program 1 is authorized to execute, and retrieve the corresponding time interval of 10 minutes. The managing program may then send the time interval of 10 minutes to the monitored program. The monitored program would then know that it must send another request for authorization to execute message within 10 minutes to continue executing, or else it may be terminated. In another example, if the monitored program is identified as “Program 4,” the managing program may use the authorization table to determine that Program 4 is not authorized to execute. The managing program may then respond in a number of ways, such as seeking authorization for the monitored program from the monitoring program, recording the number of attempts a monitored program seeks to request authorization, or send a termination message to the monitored program.

It can be appreciated that Table 1 is illustrative in nature and that the embodiments of the invention are not limited in this context. For example, the authorization table may omit a field for “Authorization” and merely use the field for “Time Interval” to imply whether authorization is granted. For example, the field for “Time Interval” may contain a default value that may be defined to mean authorization was not permitted, such as “NA” or “0”.

Furthermore, it can be appreciated that the length of the time interval may vary according to a particular network or system configuration. As a general matter, the shorter the time interval the more accurate the usage time may be determined. For example, if a monitored program were to terminate prematurely, a smaller time interval would approximate total usage time for the monitored program more accurately than a larger time interval. This may be particularly important if a user were charged for use of a monitored program based on the usage time, for example.

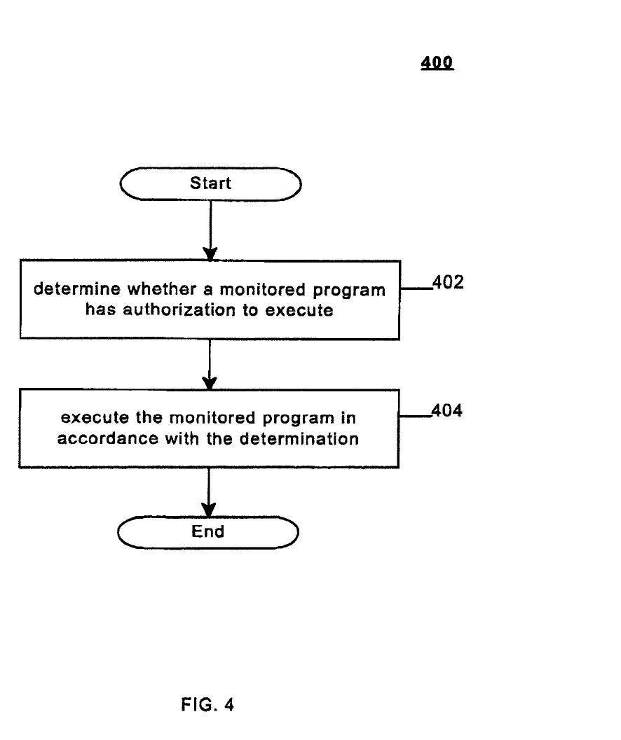

FIG. 4 is a block flow diagram of the programming logic performed by a monitored program module in accordance with one embodiment of the invention. The term monitored program module refers to the software and/or hardware used to implement the functionality for requesting authorization to execute, and if necessary terminating the monitored program, as described further herein. In this embodiment of the invention, network node 104 may perform the functionality described with reference to the monitored program module. It can be appreciated that this functionality, however, may be implemented by any device, or combination of devices, located anywhere in a communication network and still fall within the scope of the invention.

FIG. 4 illustrates a programming logic 400 that when executed by a processor, such as processor 202, may perform the functionality described therein. A determination is made as to whether a monitored program has authorization to execute at block 402. At block 404, the monitored program is executed in accordance with the determination at block 402.

In one embodiment of the invention, the determination at block 402 may comprise a query to a managing program. For example, the monitored program may send a message to the managing program requesting authorization to execute. The managing program may respond by sending the monitored program authorization to execute, along with a time interval for execution. This process may be repeated by having the monitored program send another request for authorization prior to the received time interval. In other words, the monitored program may execute as long as it receives proper authorization from the managing program in the form of a received message with a time interval. Once the monitored program is finished executing, such as when it receives a request to terminate from a user, the monitored program may send a termination message to the managing program. The termination message may inform the managing program that execution of the monitored program has been terminated.

In one embodiment of the invention, the monitored program may be instructed to terminate if the monitored program fails to receive an authorization message and time interval from the managing program within a predetermined time period. The predetermined time period may be any desired period of time, e.g., 10 minutes. In another embodiment of the invention, the monitored program may be instructed to terminate if the monitored program fails to receive an authorization message and time interval from the managing program after a predetermined number of requests for authorization to execute without reply. In both cases, the failure to receive an authorization message from the managing program may indicate that the monitored program is no longer running in a secure environment and therefore reliable usage time may not be guaranteed by the monitoring process.

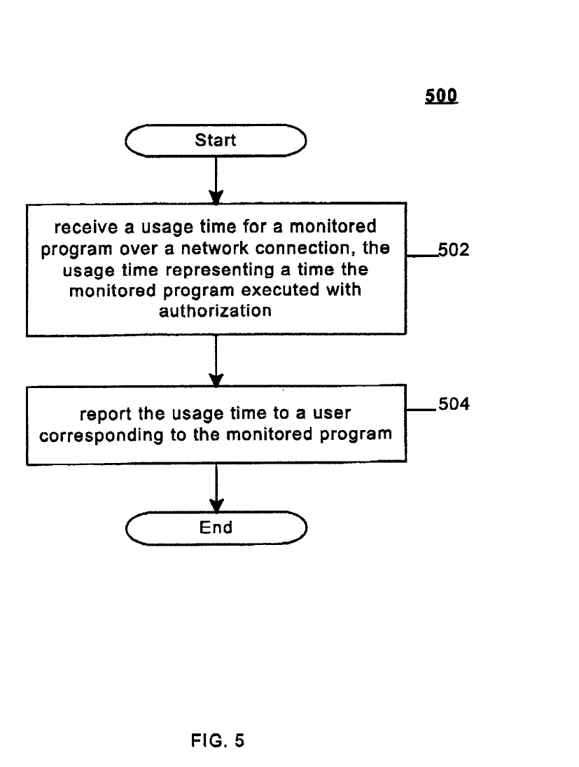

FIG. 5 is a block flow diagram of the programming logic performed by a monitoring program module in accordance with one embodiment of the invention. The term monitoring program module refers to the software and/or hardware used to implement the functionality for monitoring usage time for a monitored program as described herein. In this embodiment of the invention, network server 118 may perform the functionality described with reference to the monitored program module. It can be appreciated that this functionality, however, may be implemented by any device, or combination of devices, located anywhere in a communication network and still fall within the scope of the invention.

FIG. 5 illustrates a programming logic 500 that when executed by a processor, such as processor 202, may perform the functionality described therein. A usage time for a monitored program is received over a network connection at block 502. The usage time may be reported to a user corresponding to the monitored program at block 504. For example, a user profile may be associated with each monitored program. The user profile may contain, for example, information regarding authorized users of the monitored program, a person responsible for paying for use of the monitored program, costs associated with using the monitored program, a billing address for the responsible person, and so forth. The monitoring program may use the user profile to automatically determine a cost value for use of the monitored program based on the usage time, and send a bill to the person responsible for paying for such use. The term “automatically” as used herein refers to performing the stated function without human intervention.

In addition, the monitoring program may create, manage and update authorization tables for the managing program. For example, if a new monitored program were to be managed by the managing program, the appropriate information would be added to the authorization table for the managing program. In one embodiment of the invention, this could be accomplished by sending the modifications to the managing program and having the managing program update its own authorization table. In another embodiment of the invention, the monitoring program may send a new authorization table to the managing program to replace the previous authorization table. In both cases, the monitoring program may update the authorization on a periodic basis, or when the monitoring program receives a modification request from, for example, the managing program or an authorized user as defined in the user profile.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

### APPENDIX A

William E. Alford, Reg. No. 37,764;Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No. 39.637; Donna Jo Coningsby, Reg. No. 41,684; Florin Corie, Reg. No. 46,244; Dennis M. deguzman, Reg. No. 41,702; Stephen M. De Klerk, Reg. No. P46,503; Michael Anthony DeSanctis, Reg. No. 39,957; Daniel M. De Vos, Reg. No. 37,813; Justin M. Dillon, Reg. No. 42,486 ; Sanjeet Dutta, Reg. No. P46,145; Matthew C. Fagan, Reg. No. 37,542; Tarek N. Fahmi, Reg. No. 41,402; George Fountain, Reg. No. 37,374; James Y. Go, Reg. No. 40,621; James A. Henry, Reg. No. 41,064; Willmore F. Holbrow III, Reg. No. P41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; Erica W. Kuo, Reg. No. 42,775; George B. Leavell, Reg. No. 45,436; Kurt P. Leyendecker, Reg. No. 42,799; Gordon R. Lindeen II, Reg. No. 33,192; Jan Carol Little, Reg. No. 41,181; Robert G. Litts, Reg. No. 46,876; Julio Loza, Reg. No. P47,758; Joseph Lutz, Reg. No. 43,765; Michael J. Mallie, Reg. No. 36,591; Andre L. Marais, under 37 C.F.R. § 10.9(b); Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Daniel E. Ovanezian, Reg. No. 41,236; Kenneth B. Paley, Reg. No. 38,989; Gregg A. Peacock, Reg. No. 45,001; Marina Portnova, Reg. No. P45,750; Michael A. Proksch, Reg. No. 43,021; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Jeffrey Sam Smith, Reg. No. 39,377; Maria McCormack Sobrino, Reg. No. 31,639; Stanley W. Sokoloff, Reg. No. 25,128; Judith A. Szepesi, Reg. No. 39,393; Vincent P. Tassinari, Reg. No. 42,179; Edwin H. Taylor, Reg. No. 25,129; John F. Travis, Reg. No. 43,203; Joseph A. Twarowski, Reg. No. 42,191; Kerry D. Tweet, Reg. No. 45,959; Mark C. Van Ness, Reg. No. 39,865; Thomas A. Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. P46,322; Thomas C. Webster, Reg. No. P46,154; and Norman Zafman, Reg. No. 26,250; my patent attorneys, and Raul Martinez, Reg. No. 46,904, my patent agents; of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and Alan K. Aldous, Reg. No. 31,905; Robert D. Anderson, Reg. No. 33,826; Joseph R. Bond, Reg. No. 36,458; Richard C. Calderwood, Reg. No. 35,468; Paul W. Churilla, Reg. No. P47,495; Jeffrey S. Draeger, Reg. No. 41,000; Cynthia Thomas Faatz, Reg No. 39,973; Sean Fitzgerald, Reg. No. 32,027; John N. Greaves, Reg. No. 40,362; John F. Kacvinsky, Reg No. 40,040; Seth Z. Kalson, Reg. No. 40,670; David J. Kaplan, Reg. No. 41,105; Charles A. Mirho, Reg. No. 41,199; Leo V. Novakoski, Reg. No. 37,198; Naomi Obinata, Reg. No. 39,320; Thomas C. Reynolds, Reg. No. 32,488; Kenneth M. Seddon, Reg. No. 43,105; Mark Seeley, Reg. No. 32,299; Steven P. Skabrat, Reg. No. 36,279; Howard A. Skaist, Reg. No. 36,008; Steven C. Stewart, Reg. No. 33,555; Raymond J. Werner, Reg. No. 34,752; Robert G. Winkle, Reg. No. 37,474; Steven D. Yates, Reg. No. 42,242, and Charles K. Young, Reg. No. 39,435; my patent attorneys, Thomas Raleigh Lane, Reg. No. 42,781; Calvin E. Wells; Reg. No. P43,256. Peter Lam, Reg. No. 44,855; Michael J. Nesheiwat, Reg. No. P47,819; and Gene I. Su, Reg. No. 45,140; my patent agents, of INTEL CORPORATION; and James R. Thein, Reg. No. 31,710, my patent attorney; with full power of substitution and revocation, to prosecute this application and to transact all business in the Patent and Trademark Office connected herewith.

1. A method to manage use of a program, comprising:
determining whether a monitored program is authorized to execute;
measuring a usage time for said monitored program; and
sending said usage time to a monitoring program.

2. The method of claim 1, wherein said determining comprises:
a) receiving a request for authorization to execute from said monitored program;
b) authorizing said monitored program to execute for a time interval; and
c) sending said time interval to said monitored program.

3. The method of claim 2, further comprising repeating operations a) to c) until a terminating event has occurred.

4. The method of claim 3, wherein said measuring comprises adding each time interval together to form said usage time once said terminating event has occurred.

5. The method of claim 3, wherein said terminating event comprises receiving a message indicating execution has stopped.

6. The method of claim 3, wherein said terminating event comprises failure to receive another request for authorization to execute within said time interval.

7. The method of claim 2, wherein operations a) and c) are performed using encrypted messages.

8. The method of claim 1, wherein said monitoring program resides at a server, and sending said usage time comprises:
requesting a connection to said server;
connecting to said server; and
sending said usage time to said monitoring program over said connection.

9. The method of claim 8, wherein said connection comprises a hypertext transfer protocol connection.

10. The method of claim 8, wherein said connection comprises a secure hypertext transfer protocol connection.

11. The method of claim 2, wherein said authorizing comprises retrieving said time interval from an authorization table having at least one monitored program and corresponding time interval.

12. A method to monitor use of a program, comprising:
receiving a usage time for a monitored program over a network connection, said usage time representing a time said monitored program executed with authorization; and
reporting said usage time to a user corresponding to said monitored program.

13. The method of claim 12, further comprising:
determining a cost value associated with said usage time; and
sending said cost value to said user.

14. The method of claim 12, further comprising sending an authorization table to a managing program, said authorization table having at least one monitored program and a corresponding time interval.

15. A method to manage use of a program, comprising:
determining whether a monitored program has authorization to execute; and
executing said monitored program in accordance with said determination.

16. The method of claim 15, wherein said determining comprises:
requesting authorization to execute from a managing program; and
receiving authorization to execute from said managing program.

17. The method of claim 16, further comprising sending a termination message to said managing program.

18. The method of claim 15, wherein said determining comprises:
requesting authorization to execute from a managing program; and
failing to receive authorization to execute from said managing program within a predetermined time period.

19. The method of claim 18, further comprising terminating execution of said monitored program.

20. A method to monitor use of a program, comprising:
determining whether a monitored program is authorized to execute;
measuring a usage time associated with said monitored program;
reporting to a monitoring program said usage time; and
receiving said usage time at said monitoring program.

21. The method of claim 20, wherein said determining comprises:
requesting authorization to execute a monitored program;
authorizing said execution for a time interval; and
determining whether said monitored program has executed for said time interval.

22. An article comprising:
a storage medium;
said storage medium including stored instructions that, when executed by a processor, result in determining whether a monitored program is authorized to execute, measuring a usage time for said monitored program, and sending said usage time to a monitoring program.

23. The article of claim 22, wherein the stored instructions, when executed by a processor, further result in determining whether a monitored program is authorized to execute by receiving a request for authorization to execute from said monitored program, authorizing said monitored program to execute for a time interval, and sending said time interval to said monitored program.

24. The article of claim 22, wherein the stored instructions, when executed by a processor, further result in sending said usage time by requesting a connection to said server, connecting to said server, and sending said usage time to said monitoring program over said connection.

25. The article of claim 22, wherein the stored instructions, when executed by a processor, further result in connecting to said server using a hypertext transfer protocol connection.

26. The article of claim 22, wherein the stored instructions, when executed by a processor, further result in connecting to said server using a secure hypertext transfer protocol connection.

27. An article comprising:
a storage medium;
said storage medium including stored instructions that, when executed by a processor, result in receiving a usage time for a monitored program over a network connection, said usage time representing a time said monitored program executed with authorization, and reporting said usage time to a user corresponding to said monitored program.

28. The article of claim 27, wherein the stored instructions, when executed by a processor, further result in determining a cost value associated with said usage time, and sending said cost value to said user.

29. The article of claim 28, wherein the stored instructions, when executed by a processor, further result in sending an authorization table to a managing program, said authorization table having at least one monitored program and a corresponding time interval.

30. An article comprising:
a storage medium;
said storage medium including stored instructions that, when executed by a processor, result in determining whether a monitored program has authorization to execute, and executing said monitored program in accordance with said determination.

31. The article of claim 30, wherein the stored instructions, when executed by a processor, further result in determining whether a monitored program has authorization to execute by requesting authorization to execute from a managing program, and receiving authorization to execute from said managing program.

32. An article comprising:
a storage medium;
said storage medium including stored instructions that, when executed by a processor, result in determining whether a monitored program is authorized to execute, measuring a usage time associated with said monitored program, reporting to a monitoring program said usage time, and receiving said usage time at said monitoring program.

33. The article of claim 32, wherein the stored instructions, when executed by a processor, further result in determining whether a monitored program has authorization to execute by requesting authorization to execute a monitored program, authorizing said execution for a time interval, and determining whether said monitored program has executed for said time interval.
